(19) United States
(12) Patent Application Publication
(10) Pub. No.: US 2026/0029034 A1
(43) Pub. Date: Jan. 29, 2026

(54) TUNED DAMPER SYSTEM AND METHOD OF USING TUNED DAMPER SYSTEM

(71) Applicant: Cummins Inc., Columbus, IN (US)

(72) Inventors: Neil Williamson, Lutterworth (GB); Stuart J. Morris, Daventry (GB)

(73) Assignee: Cummins Inc., Columbus, IN (US)

(21) Appl. No.: 19/283,036

(22) Filed: Jul. 28, 2025

(30) Foreign Application Priority Data
Jul. 29, 2024 (GB) 2411045.4

(51) Int. Cl. F16F 7/10

(52) U.S. Cl. CPC F16F 7/1028

(57) ABSTRACT

A damper system for an engine includes an adapter configured to couple to an end of an induction tube within the engine and a tubular member having a first end and a second end, the first end being configured to concentrically couple to an end of the adapter and the second end being configured for coupling to a turbo system. The adapter includes a flange portion and a cannular portion extending from the flange portion, the cannular portion having a constant diameter and at least partially overlapping with the first end of the tubular member, and where at least one of the adapter or the tubular member has a predetermined mass configured to dampen axial motion between the induction tube and the turbo system.

### CROSS-REFERENCE TO RELATED APPLICATIONS

This application claims the benefit of and priority to United Kingdom Application No. 2411045.4, filed on Jul. 29, 2024, the entire disclosure of which is hereby incorporated by reference.

### TECHNICAL FIELD

The present disclosure relates generally to the field of engines, and turbocharger systems for engines.

### BACKGROUND

An engine can include a turbocharger system having one or more compressors to facilitate increasing a density of intake gas to correspondingly increase power during combustion cycles. The turbocharger system can be coupled to an intake manifold within the engine, where compressed air from the turbocharger system enters the intake manifold such that an air and fuel mixture can be provided to one or more cylinders within the engine.

### SUMMARY OF THE INVENTION

At least one aspect of the present disclosure relates to a damper system for an engine. The damper system includes an adapter configured to couple to an end of an induction tube within the engine, and a tubular member having a first end and a second end, the first end being configured to concentrically couple to an end of the adapter and the second end being configured for coupling to a turbo system. The adapter includes a flange portion and a cannular portion extending from the flange portion, the cannular portion having a constant diameter and at least partially overlapping with the first end of the tubular member. At least one of the adapter or the tubular member has a predetermined mass configured to dampen axial motion between the induction tube and the turbo system.

In various embodiments, the system further includes at least one clamping member configured to couple to the tubular member. In some embodiments, the at least one clamping member includes a first clamping member and a second clamping member, the first clamping member configured to couple the first end of the tubular member to the cannular portion of the adapter and the second clamping member being configured for coupling the second end to the turbo system. In other embodiments, the at least one clamping member is a banded clip. In yet other embodiments, the banded clip includes stainless steel. In various embodiments, the tubular member is a hose. In some embodiments, the hose includes a material structured to withstand an operating temperature of at least 200° C. In other embodiments, the hose is a rubber hose. In yet other embodiments, the hose has a thickness of less than approximately 10 mm. In various embodiments, the predetermined mass is between approximately 5% and approximately 10% of a mass of the turbo system. For example, the predetermined mass can be between approximately 7% and approximately 10% of a mass of the turbo system. In some embodiments, the damper system is configured to dampen the axial motion by an amount between approximately 45% and approximately 60% as compared to an amount of undamped axial motion. For example, the damper system can be configured to dampen the axial motion by an amount between approximately 46% and 59% as compared to an amount of undamped axial motion.

Another aspect of the present disclosure relates to an engine system. The engine system includes an induction tube, a turbo system having an intake port, the intake port being in fluid communication with an end of the induction tube, and a damper system configured to reduce an amount of axial motion within the induction tube. The damper system includes an adapter configured to couple to the end of the induction tube and a tubular member configured to extend between the adapter and the intake port, wherein at least one of the adapter or the tubular member has a predetermined mass configured to dampen axial motion between the induction tube and the turbo system.

In various embodiments, the tubular member is structured to withstand an operating temperature of at least approximately 200° C. In some embodiments, the tubular member is a rubber hose. In other embodiments, the damper system is configured to be retrofitted within the engine system. In yet other embodiments, the adapter includes a flange portion structured to couple to the end of the induction tube, and a cannular portion extending from the flange portion, where the cannular portion is structured to couple to the tubular member. In various embodiments, the tubular member is structured to axially overlap with at least a portion of the cannular portion and at least a portion of the intake port.

Yet another aspect of the present disclosure relates to a method of dampening axial motion within an engine system. The method includes determining an amount of axial motion within the engine system and coupling a dampening system between an induction tube and a turbo system within the engine system, the dampening system comprising an adapter and a tubular member coupled to the adapter, wherein at least one of the adapter or the tubular member has an integrally formed and predetermined mass. The method also includes dampening the amount of axial motion using the predetermined mass.

In various implementations, coupling the dampening system includes setting the predetermined mass of the at least one of the adapter or the tubular member. In various implementations, setting the predetermined mass of the at least one of the adapter or the tubular member includes selecting a length of at least one of the adapter or the tubular member, and selecting an axial thickness of at least one of the adapter or the tubular member. In various implementations, setting the predetermined mass of the at least one of the adapter or the tubular member includes setting the predetermined mass to be between approximately 5% and approximately 10% of a mass of the turbo system. In some implementations, coupling the dampening system between the induction tube and the turbo system includes coupling the adapter to an end of the induction tube, clamping a first end of the tubular member to the adapter, and clamping a second end of the tubular member to an intake port of the turbo system. In other implementations, clamping the first end of the tubular member to the adapter includes inserting an end of the adapter within the first end of the tubular member and coupling the first end of the tubular member to the end of the adapter via a first clip, and wherein clamping the second end of the tubular member to the intake port of the turbo system and inserting the intake port within the second end of the tubular member and coupling the second end of the tubular member to the intake port via a second clip. In yet other implementations, coupling the first end of the tubular member to the end of the adapter via the first clip includes tightening the first clip about the first end of the tubular member and coupling the second end of the tubular member to the intake port via the second clip comprises tightening the second clip about the second end of the tubular member, each of the first clip and the second clip comprising stainless steel. In various implementations, the adapter includes a flange portion and a cannular portion extending from the flange portion, the cannular portion having a substantially constant diameter.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of an engine system that includes a damping system, according to at least one embodiment.

FIG. 2 is a partial cross-sectional view of the damping system of FIG. 1, according to at least one embodiment.

FIG. 3 is a side view of the damping system of FIG. 1, according to at least one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are contemplated and made part of this disclosure.

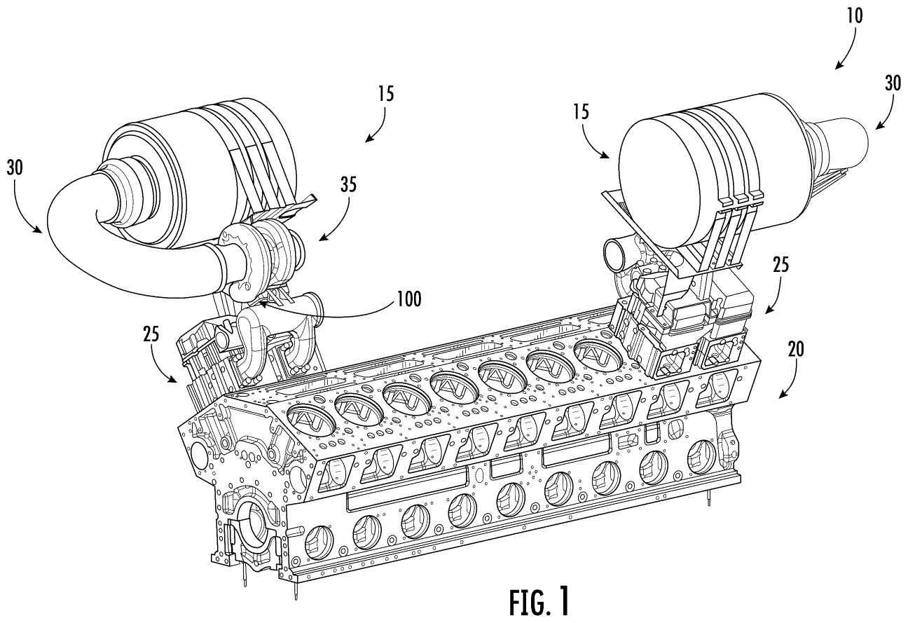

Referring to FIG. 1, an engine system 10 for an internal combustion engine is shown, according to at least one embodiment. In various embodiments, the engine system 10 includes at least one intake assembly 15, which is configured to direct air to a cylinder block 20, where the air is provided to at least one cylinder to facilitate combustion. In various embodiments, such as shown in FIG. 1, the engine system 10 can include two intake assemblies 15. Each intake assembly 15 can include an intake conduit 30, which is in fluid connection with a turbo system 35. The intake conduit 30 can be shaped as a tube. The induction tube 30 is structured to receive air and direct the air to the turbo system 35. The turbo system 35 can include a turbo charger, which is configured to compress the air received by the induction tube 30. Compressed air from the turbo system 35 can flow to at least a portion of an intake manifold 25. The intake manifold 25 can distribute the compressed air to the cylinder head 20.

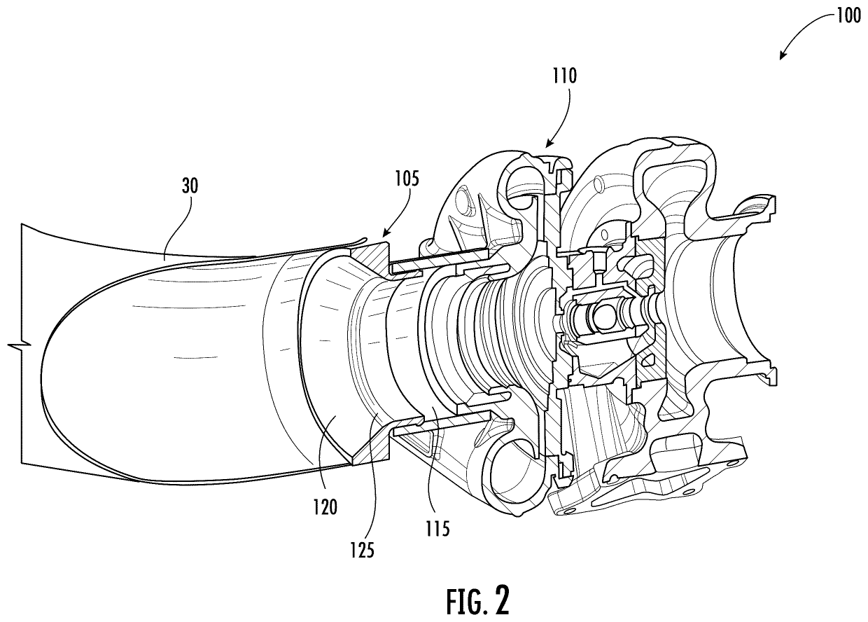

During operation, the engine system 10 can be subject to and/or generate vibration therein. In various embodiments, the vibration can be in the form of axial motion along an axis defined by the induction tube 30 and/or an intake portion of the turbo system 35. To reduce the axial motion within the engine system 10, the engine system 10 can be structured to include a damper system 100, such as shown in FIGS. 1-2. In various embodiments, the damper system 100 can be coupled between the induction tube 30 and an intake port 110 of the turbo system 35 such that the induction tube 30 is in fluid communication with the intake port 110. The damper system 100 can be structured to dampen (i.e., reduce) the axial motion by an amount that is between approximately 45% and approximately 60% as compared to an amount of undamped axial motion (i.e., as compared to a configuration of the engine system 10 without the damping system 100). For example, the damper system 100 can dampen the axial motion by an amount that is between approximately 46% and approximately 59% as compared to an amount of undamped axial motion.

As shown in FIG. 2, the damping system 100 can include an adapter 105, which is configured to couple to an end of the induction tube 30. The damping system 100 can also include a tubular member 115, which is structured to couple to an end of the adapter 105. The tubular member 115 includes a first end and a second end, where the first end is structured to couple to the end of the adapter 105 and the second is configured to couple to the turbo system 35. In various embodiments, the second end is configured to couple to the intake port 110 of the turbo system 35.

As shown in FIG. 2, the adapter 105 can include a flange portion 120 and a cannular portion 125 extending from the flange portion 120. In various embodiments, the flange portion 120 is structured such that a diameter of the flange portion 120 increases from the cannular portion 125 to the first end of the adapter 105. In some embodiments, the cannular portion 125 is structured such that a diameter of the cannular portion 125 remains constant from the flange portion 120 to the second end of the adapter 105.

As illustrated in FIG. 2, the adapter 105 can be arranged within the damper system 100 such that the at least a portion of the adapter 105 at least partly overlaps with the tubular member 115. For example, in some embodiments, the adapter 105 can be structured such that the cannular portion 125 axially overlaps with an end of the tubular member 115. In various embodiments, the tubular member 115 axially overlaps with at least a portion of the cannular portion 125 and at least a portion of the intake port 110.

The damper system 100 can be structured to have a predetermined mass such that the damper system 100 reduces the amount of the axial motion within the engine system 10. In various embodiments, the damper system 100 can be configured such that at least one component of the damper system 100 has a predetermined mass that facilitates damping the amount of axial motion within the engine system 10. In some embodiments, the at least one component is the adapter 105. In other embodiments, the at least one component is the tubular member 115. In some embodiments, the at least one component can be structured such that the predetermined mass is integral to the at least one component. For example, in some embodiments, the predetermined mass of the at least one component can be set based on a thickness, density, length, diameter, and/or other suitable dimension. In yet other embodiments, the at least one component can be structured such that the predetermined mass is coupled to the at least one component. For example, in some embodiments, the predetermined mass can be coupled to at least one of the adapter 105 or the tubular member 115. In various embodiments, the predetermined mass is between approximately 7% and 10% of a total mass of the turbo system 35.

In some embodiments, the tubular member 115 is a hose. For example, in some embodiments, the tubular member 115 is a rubber hose. In various embodiments, the tubular member 115 can have a thickness of approximately 9 mm. In other embodiments, the tubular member 115 is structured withstand an operating temperature within the engine system of at least 200° C.

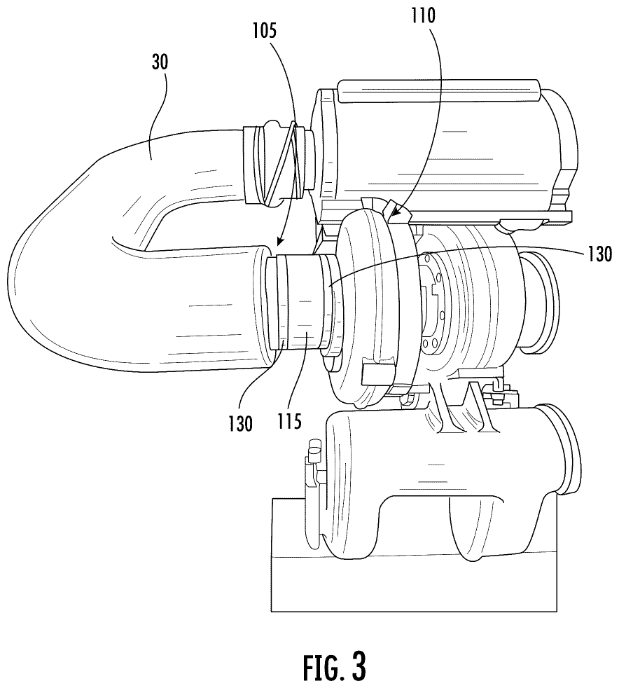

In some embodiments, the damper system 100 includes at least one clamping member to facilitate coupling one or more components of the damper system 100 within the engine system 10. As shown in FIG. 3, the damper system 100 includes at least one clamping member 130, which is configured to couple to the tubular member 115. In various embodiments, the at least one clamping member 130 is a banded clip. For example, the at least one clamping member 130 can be a stainless steel banded clip.

In some embodiments, the at least one clamping member 130 includes a first clamping member 130 and a second clamping member 130. For example, in some embodiments, the first clamping member 130 can be configured to couple to the first end of the tubular member 115 to facilitate coupling the tubular member 115 to the cannular portion 125 of the adapter 105. Similarly, the second clamping member 130 can be configured to couple to the second end of the tubular member 115 to facilitate coupling the tubular member to the turbo system 35. For example, the second clamping member 130 can couple the second end of the tubular member 115 to the intake port 110.

In various embodiments, the damper system 100 can be configured to be retrofit within the engine system 10. For example, the damper system 100 can be separately provided and coupled to the engine system 10 to reduce axial motion therein. In other embodiments, the engine system 10 can be configured to include the damper system 100 at manufacturing.

In various embodiments, the damper system 100 for an engine (i.e., the engine system 10) includes the adapter 105 configured to couple to an end of an induction tube 30 within the engine. The damper system 100 also includes the tubular member 115 having a first end and a second end, the first end being configured to concentrically couple to an end of the adapter 105 and the second end being configured for coupling to the turbo system 35. In various embodiments, the adapter 105 comprises the flange portion 120 and the cannular portion 125 extending from the flange portion 120, the cannular portion 125 having a constant diameter and at least partially overlapping with the first end of the tubular member 115. In some embodiments, at least one of the adapter 105 or the tubular member 115 has a predetermined mass configured to dampen axial motion between the induction tube 30 and the turbo system 35.

Accordingly, when assembled, the engine system 10 can include the induction tube 30, the turbo system 35 having the intake port 110, the intake port 110 being in fluid communication with an end of the induction tube 30, and the damper system 100 configured to reduce an amount of axial motion within the induction tube 30. In various embodiments, the damper system includes the adapter 105 configured to couple to the end of the induction tube 30, and a tubular member 115 configured to extend between the adapter 105 and the intake port 110. In various embodiments, at least one of the adapter 105 or the tubular member 115 has a predetermined mass configured to dampen axial motion between the induction tube 30 and the turbo system 35.

In various embodiments, dampening axial motion within the engine system 10 can be carried out by optionally determining an amount of axial motion within the engine system 10. For example, in some implementations, determining the amount of axial motion within the engine system 10 be carried out by determining the amount of axial motion between the induction tube 30 and the intake port 110 of the turbo system 35. In some embodiments, the amount of axial motion can be estimated based on a type of the engine system 10. In other implementations, the amount of axial motion can be determined by one or more sensors within the engine system 10. In yet other implementations, the amount of axial motion can be determined through experimental tests.

In some embodiments, dampening axial motion within the engine system 10 can be carried out without determining the amount of axial motion within the engine system 10. Rather, a method of dampening axial motion within the engine system 10 can include coupling the damper system 100 within the engine system 10. In some implementations, the method can additionally include setting the predetermined mass within the damper system 100 prior to coupling the damper system 100 within the engine system 10.

Either during manufacturing or through retrofitting, the damper system 100 can be coupled within the engine system 10 between the induction tube 30 and the turbo system 35. When coupled, the damper system 100 can be arranged such that the adapter 105 is coupled to a portion of the induction tube 30 and the tubular member 115 is coupled to a portion of the intake port 110. In various embodiments, at least one of the adapter 105 or the tubular member 115 includes an integrally formed and predetermined mass. Accordingly, when coupled within the engine system 10, the damper system 100 is configured to dampen the amount of axial motion via the predetermined mass.

In various embodiments, retrofitting the damper system 100 to the engine system 10 can include determining a mass (e.g., a total mass) of the turbo system 35. In various embodiments, the mass of the turbo system 35 corresponds to a mass of the turbo system 35 without any fittings and/or fixings. Using the mass of the turbo system 35, the predetermined mass corresponding to a mass of the adapter 105 and/or the tubular member 115 can then be determined. For example, in some embodiments, the predetermined mass is selected to be between about 5% and about 10% of the mass of the turbo system 35. Once the predetermined mass is determined, at least one dimension of at least one of the adapter 105 or the tubular member 115 can be selected such that the corresponding mass of the adapter 105 and/or the tubular member 115 equals the predetermined mass. For example, in various implementations, the adapter 105 and/or tubular member 115 can be fabricated, modified, or selected to have a known thickness, diameter, length, and/or density such that the mass of the adapter 105 is equivalent to the predetermined mass. In some embodiments, the diameter of the adapter 105 and/or tubular member 115 can be determined based on one or more parameters of the engine 10 (e.g., a diameter of the induction tube 30).

Once the mass of the adapter 105 and/or tubular member 115 is set (i.e., to be equivalent to the predetermined mass), the damper system 100 can be coupled within the engine 10. For example, the adapter 105 can be coupled to the induction tube 30 and the tubular member 115 can be coupled to the intake port 110. The adapter 105 can be coupled to the tubular member 115. Accordingly, once the damper system 100 is coupled within the engine system 10, the damper system can dampen vibration (e.g., axial motion) along a turbo shaft within the turbo system 35. In various embodiments, the damper system 100 can be retrofit to any engine 10 system for which it is determined that there is a sufficient amount of space between the induction tube 30 and the intake port 110 to accommodate insertion of the damper system 100. By retrofitting the damper system 100 to the engine system 10, vibration from the turbo system 35 can be dampened without requiring modification or replacement of the turbo system 35 itself.

Generally, in various embodiments, coupling the damper system 100 within the engine system 10 includes setting the predetermined mass of the adapter 105 and/or the tubular member 115. In various embodiments, setting the predetermined mass includes selecting at least one dimension of at least one of the adapter 105 or the tubular member 115. For example, in some embodiments, setting the predetermined mass of at least one of the adapter 105 or the tubular member 115 includes selecting a length of at least one of the adapter 105 or the tubular member 115. Setting the predetermined mass of at least one of the adapter 105 or the tubular member 115 can additionally or alternatively include selecting an axial thickness of at least one of the adapter 105 or the tubular member 115. As indicated above, setting the predetermined mass of at least one of the adapter 105 or the tubular member 115 includes setting the predetermined mass to be between approximately 5% and approximately 10% of a mass of at least a portion of the engine system 10. For example, the predetermined mass can be set to be between approximately 7% and approximately 10% of a mass of the turbo system 35. In various embodiments, setting the predetermined mass is based on at least one of the amount of axial motion or the mas of the portion of the engine system 10.

In various implementations, coupling the damper system 10 within the engine system 100 can include coupling the adapter 105 to an end of the induction tube 30. Methods of coupling the damper system 10 within the engine system 100 can further include clamping the first end of the tubular member 115 to the adapter 105 and clamping a second end of the tubular member 115 to the intake port 110 of the turbo system 35. In various implementations, clamping the first end of the tubular member 115 to the adapter 105 can include inserting an end of the adapter 105 within the first end of the tubular member 115 and coupling the first end of the tubular member 115 to the end of the adapter 105 using a first clip (i.e., a first clamping member 130). In various embodiments, the end of the adapter 105 coupled to the first end of the tubular member 115 is disposed within the cannular portion 125. In various implementations, clamping the second end of the tubular member 115 to the intake port 110 of the turbo system 35 includes inserting the intake port 110 within the second end of the tubular member 115 and coupling the second end of the tubular member 115 to the intake port 110 via a second clip (i.e., a second clamping member 130).

In various implementations, coupling the first end of the tubular member 115 to the end of the adapter 105 via the first clip can include tightening the first clip about the first end of the tubular member 115. In other implementations, coupling the second end of the tubular member 115 to the intake port 110 via the second clip can include tightening the second clip about the second end of the tubular member 115. As described above, in various embodiments, each of the first clip (i.e., first clamping member 130) and the second clip (i.e., second clamping member 130) can include stainless steel. In other embodiments, the first clip and/or the second clip can include any suitable material known in the art.

Accordingly, in various implementations, a method of dampening axial motion within the engine system 10 can include determining an amount of axial motion within the engine system 10. The method can further include coupling the dampening system 100 between the induction tube 30 and the turbo system 35 within the engine system 10. In various embodiments, the dampening system 100 comprises an adapter 105 and a tubular member 115 coupled to the adapter 105, wherein at least one of the adapter 105 or the tubular member 115 has an integrally formed and predetermined mass. The method can also include dampening the amount of axial motion using the predetermined mass.

Notwithstanding the embodiments described above in reference to FIGS. 1-3, various modifications and inclusions to those embodiments are contemplated and considered within the scope of the present disclosure.

The present technology may also include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A damper system for an engine, the damper system comprising:
   an adapter configured to couple to an end of an induction tube within the engine; and
   a tubular member having a first end and a second end, the first end being configured to concentrically couple to an end of the adapter and the second end being configured for coupling to a turbo system,
   wherein the adapter comprises a flange portion and a cannular portion extending from the flange portion, the cannular portion having a constant diameter and at least partially overlapping with the first end of the tubular member; and
   wherein at least one of the adapter or the tubular member has a predetermined mass configured to dampen axial motion between the induction tube and the turbo system.
B. The damper system of paragraph A, further comprising at least one clamping member configured to couple to the tubular member.
C. The damper system of paragraph A, wherein the at least one clamping member comprises a first clamping member and a second clamping member, the first clamping member configured to couple the first end of the tubular member to the cannular portion of the adapter and the second clamping member being configured for coupling the second end to the turbo system.
D. The damper system of any of paragraphs B or C, wherein the at least one clamping member is a banded clip.
E. The damper system of paragraph D, wherein the banded clip comprises stainless steel.
F. The damper system of any one of the preceding paragraphs, wherein the tubular member is a hose.
G. The damper system of paragraph F, wherein the hose comprises a material structured to withstand an operating temperature of at least 200° C.
H. The damper system of paragraph F, wherein the hose is a rubber hose.
I. The damper system of paragraphs G or H, wherein the hose has a thickness of approximately 9 mm.
J. The damper system of any one of the preceding paragraphs, wherein the predetermined mass is between approximately 5% and approximately 10% of a mass of the turbo system.
K. The damper system of any one of the preceding paragraphs, wherein the damper system is configured to dampen the axial motion by an amount between approximately 45% and approximately 60% as compared to an amount of undamped axial motion.
L. An engine system comprising:
   an induction tube;
   a turbo system having an intake port, the intake port being in fluid communication with an end of the induction tube; and
   a damper system configured to reduce an amount of axial motion within the induction tube, the damper system comprising:
      an adapter configured to couple to the end of the induction tube; and
      a tubular member configured to extend between the adapter and the intake port;
      wherein at least one of the adapter or the tubular member has a predetermined mass configured to dampen axial motion between the induction tube and the turbo system.
M. The engine system of paragraph L, wherein the tubular member is structured to withstand an operating temperature of at least 200° C.
N. The engine system of paragraph L or M, wherein the tubular member is a rubber hose.
O. The engine system of any one of claims L to N, wherein the damper system is configured to be retrofitted within the engine system.
P. The engine system of any one of claims L to O, wherein the adapter comprises:
   a flange portion structured to couple to the end of the induction tube; and
   a cannular portion extending from the flange portion;
   wherein the cannular portion is structured to couple to the tubular member.
Q. The engine system of paragraph P, wherein the tubular member is structured to axially overlap with at least a portion of the cannular portion and at least a portion of the intake port.
R. A method of dampening axial motion within an engine system, the method comprising:
   determining an amount of axial motion within the engine system;
   coupling a dampening system between an induction tube and a turbo system within the engine system, the dampening system comprising an adapter and a tubular member coupled to the adapter, wherein at least one of the adapter or the tubular member has an integrally formed and predetermined mass; and
   dampening the amount of axial motion using the predetermined mass.
S. The method of paragraph R, wherein coupling the dampening system comprises setting the predetermined mass of the at least one of the adapter or the tubular member.
T. The method of paragraph S, wherein setting the predetermined mass of the at least one of the adapter or the tubular member comprises:
   selecting a length of at least one of the adapter or the tubular member; and
   selecting an axial thickness of at least one of the adapter or the tubular member.
U. The method of paragraph S or T, wherein setting the predetermined mass of the at least one of the adapter or the tubular member comprises setting the predetermined mass to be between approximately 7% and approximately 10% of a mass of the turbo system.
V. The method of any one of paragraphs R to U, wherein coupling the dampening system between the induction tube and the turbo system comprises:
   coupling the adapter to an end of the induction tube;
   clamping a first end of the tubular member to the adapter; and
   clamping a second end of the tubular member to an intake port of the turbo system.
W. The method of paragraph V, wherein clamping the first end of the tubular member to the adapter comprises:
   inserting an end of the adapter within the first end of the tubular member; and
   coupling the first end of the tubular member to the end of the adapter via a first clip; and
   wherein clamping the second end of the tubular member to the intake port of the turbo system comprises:
   inserting the intake port within the second end of the tubular member; and
   coupling the second end of the tubular member to the intake port via a second clip.
X. The method of paragraph W, wherein coupling the first end of the tubular member to the end of the adapter via the first clip comprises tightening the first clip about the first end of the tubular member and coupling the second end of the tubular member to the intake port via the second clip comprises tightening the second clip about the second end of the tubular member, each of the first clip and the second clip comprising stainless steel.
Y. The method of any one of paragraphs R to W, wherein the adapter comprises:
   a flange portion; and
   a cannular portion extending from the flange portion, the cannular portion having a substantially constant diameter.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A damper system for an engine, the damper system comprising:
an adapter configured to couple to an end of an induction tube within the engine; and
a tubular member having a first end and a second end, the first end being configured to concentrically couple to an end of the adapter and the second end being configured for coupling to a turbo system,
wherein the adapter comprises a flange portion and a cannular portion extending from the flange portion, the cannular portion having a constant diameter and at least partially overlapping with the first end of the tubular member; and
wherein at least one of the adapter or the tubular member has a predetermined mass configured to dampen axial motion between the induction tube and the turbo system.

2. The damper system of claim 1, further comprising at least one clamping member configured to couple to the tubular member.

3. The damper system of claim 2, wherein the at least one clamping member comprises a first clamping member and a second clamping member, the first clamping member configured to couple the first end of the tubular member to the cannular portion of the adapter and the second clamping member being configured for coupling the second end to the turbo system.

4. The damper system of claim 2, wherein the at least one clamping member is a banded clip.

5. The damper system of claim 4, wherein the banded clip comprises stainless steel.

6. The damper system of claim 1, wherein the tubular member is a hose, and at least one of the following is satisfied:
(i) the hose comprises a material structured to withstand an operating temperature of at least approximately 200° C.;
(ii) the hose is a rubber hose; or
(iii) the hose has a thickness of approximately 9 mm.

7. (canceled)

8. (canceled)

9. (canceled)

10. The damper system of claim 1, wherein the predetermined mass is between approximately 5% and approximately 10% of a mass of the turbo system.

11. The damper system of claim 1, wherein the damper system is configured to dampen the axial motion by an amount between approximately 45% and approximately 60% as compared to an amount of undamped axial motion.

12. An engine system comprising:
an induction tube;
a turbo system having an intake port, the intake port being in fluid communication with an end of the induction tube; and
a damper system configured to reduce an amount of axial motion within the induction tube, the damper system comprising:
an adapter configured to couple to the end of the induction tube; and
a tubular member configured to extend between the adapter and the intake port;
wherein at least one of the adapter or the tubular member has a predetermined mass configured to dampen axial motion between the induction tube and the turbo system.

13. The engine system of claim 12, wherein the tubular member is structured to withstand an operating temperature of at least approximately 200° C.

14. (canceled)

15. The engine system of claim 12, wherein the damper system is configured to be retrofitted within the engine system.

16. The engine system of claim 12, wherein the adapter comprises:
a flange portion structured to couple to the end of the induction tube; and
a cannular portion extending from the flange portion;
wherein the cannular portion is structured to couple to the tubular member.

17. The engine system of claim 16, wherein the tubular member is structured to axially overlap with at least a portion of the cannular portion and at least a portion of the intake port.

18. A method of dampening axial motion within an engine system, the method comprising:
determining an amount of axial motion within the engine system;
coupling a dampening system between an induction tube and a turbo system within the engine system, the dampening system comprising an adapter and a tubular member coupled to the adapter, wherein at least one of the adapter or the tubular member has an integrally formed and predetermined mass; and
dampening the amount of axial motion using the predetermined mass.

19. The method of claim 18, wherein coupling the dampening system comprises setting the predetermined mass of the at least one of the adapter or the tubular member.

20. The method of claim 19, wherein setting the predetermined mass of the at least one of the adapter or the tubular member comprises one of:
(i) selecting a length of at least one of the adapter or the tubular member; and selecting an axial thickness of at least one of the adapter or the tubular member, or
(ii) setting the predetermined mass to be between approximately 5% and approximately 10% of a mass of the turbo system.

21. (canceled)

22. The method of claim 18, wherein coupling the dampening system between the induction tube and the turbo system comprises:
coupling the adapter to an end of the induction tube;
clamping a first end of the tubular member to the adapter; and
clamping a second end of the tubular member to an intake port of the turbo system.

23. The method of claim 22, wherein clamping the first end of the tubular member to the adapter comprises:
inserting an end of the adapter within the first end of the tubular member; and
coupling the first end of the tubular member to the end of the adapter via a first clip; and
wherein clamping the second end of the tubular member to the intake port of the turbo system comprises:
inserting the intake port within the second end of the tubular member; and
coupling the second end of the tubular member to the intake port via a second clip.

24. The method of claim 23, wherein coupling the first end of the tubular member to the end of the adapter via the first clip comprises tightening the first clip about the first end of the tubular member and coupling the second end of the tubular member to the intake port via the second clip comprises tightening the second clip about the second end of the tubular member, each of the first clip and the second clip comprising stainless steel.

25. The method of claim 18, wherein the adapter comprises:
a flange portion; and
a cannular portion extending from the flange portion, the cannular portion having a substantially constant diameter.
